(19) United States
(12) Patent Application Publication
(10) Pub. No.: US 2021/0365991 A1
(43) Pub. Date: Nov. 25, 2021

(54) INFORMATION PROVIDING SYSTEM, VEHICLE DATA ANALYZING DEVICE, AND INFORMATION PROVIDING METHOD

(71) Applicant: DENSO CORPORATION, Kariya-city (JP)

(72) Inventor: Megumi ANAMI, Kariya-city (JP)

(21) Appl. No.: 17/243,626

(22) Filed: Apr. 29, 2021

(30) Foreign Application Priority Data
May 20, 2020 (JP) 2020-088084

(51) Int. Cl. G06Q 30/02; G07C 5/08

(52) U.S. Cl. CPC G06Q 30/0269; G07C 5/08

(57) ABSTRACT

Vehicle data including information on traveling of a plurality of vehicles driven by a plurality of drivers are acquired from a plurality of in-vehicle devices. Based on the acquired vehicle data, a property relative to traveling of a specific driver of the plurality of drivers is analyzed to generate analysis result data. Provision information is generated based on the generated analysis result data and is transmitted to a terminal device held by the specific driver.

### CROSS REFERENCE TO RELATED APPLICATION

The present application is based on Japanese Patent Application No. 2020-088084 filed on May 20, 2020, the disclosure of which is incorporated herein by reference.

### TECHNICAL FIELD

The present disclosure relates to an information providing system that provides information based on vehicle data.

### BACKGROUND

There is a technique for distributing information according to a state transition of a user's behavior when the user moves using a vehicle.

### SUMMARY

According to an example of the present disclosure, a configuration is provided as follows. That is, vehicle data including information on traveling of a plurality of vehicles driven by a plurality of drivers are acquired from a plurality of in-vehicle devices. Based on the acquired vehicle data, a property relative to traveling of a specific driver of the plurality of drivers is analyzed to generate analysis result data. Provision information is generated based on the generated analysis result data and is transmitted to a terminal device held by the specific driver.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram showing a configuration of an information providing system according to a first embodiment;

FIG. 2 is a block diagram showing a configuration of a data collecting device;

FIG, 3 is a block diagram showing a configuration of a vehicle data analyzing device and a service providing server;

FIG. 4 is a flowchart showing a data collecting process;

FIG. 5 is a flowchart showing a data analyzing process according to the first embodiment;

FIG. 6 is a block diagram showing a configuration of an information providing system according to a second embodiment;

FIG. 7 is a flowchart showing a data analyzing process according to the second embodiment; and

FIG. 8 is a flowchart showing a data analyzing process according to a third embodiment.

### DETAILED DESCRIPTION

### First Embodiment

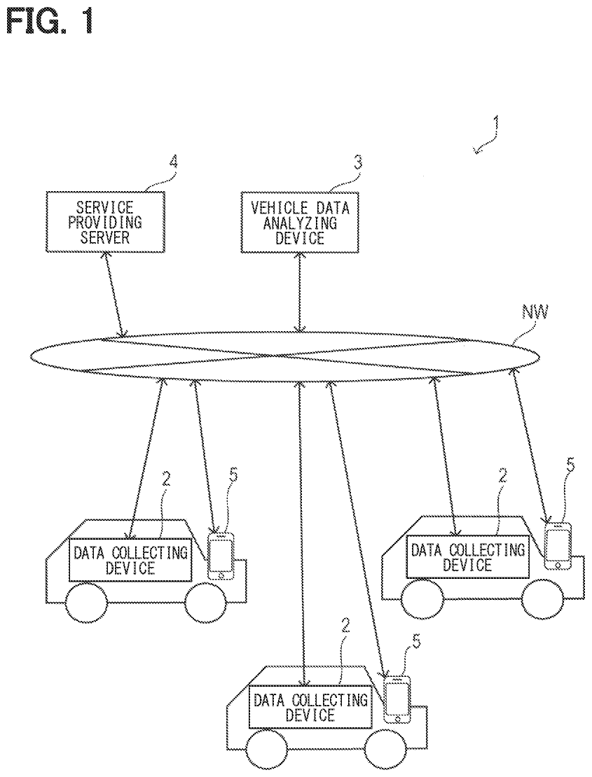

Hereinafter, a first embodiment of the present disclosure will be described with reference to the drawings. As shown in FIG. 1, the information providing system 1 of the present embodiment includes a plurality of data collecting devices 2, a vehicle data analyzing device 3, a service providing server 4, and a plurality of mobile terminals 5. The data collecting devices 2 are mounted on respective vehicles (i.e., host vehicles) and are configured to perform data communication with the vehicle data analyzing device 3 through a wireless wide area network NW. Hereinafter, the vehicle as a host vehicle equipped with the data collecting device 2 is referred to as a service target vehicle.

The mobile terminal 5 is an information processing terminal (for example, a smartphone or tablet) carried or held by a driver who drives a service target vehicle. The vehicle data analyzing device 3 has a function of analyzing data acquired from the data collecting device 2 via the wireless wide area communication network NW.

The service providing server 4 acquires analysis data from the vehicle data analyzing device 3 via the wireless wide area communication network NW. Then, the service providing server 4 has a function of transmitting predetermined service information to a plurality of mobile terminals 5 via the wireless wide area communication network NW based on the acquired analysis data. Note that the vehicle data analyzing device 3 may output the analysis data to another file server (not shown), and the service providing server 4 may acquire the analysis data from the other file server.

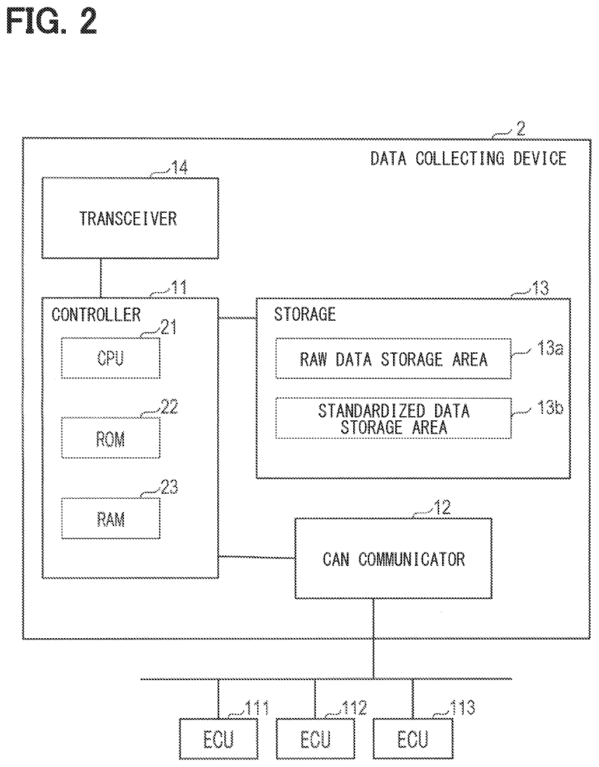

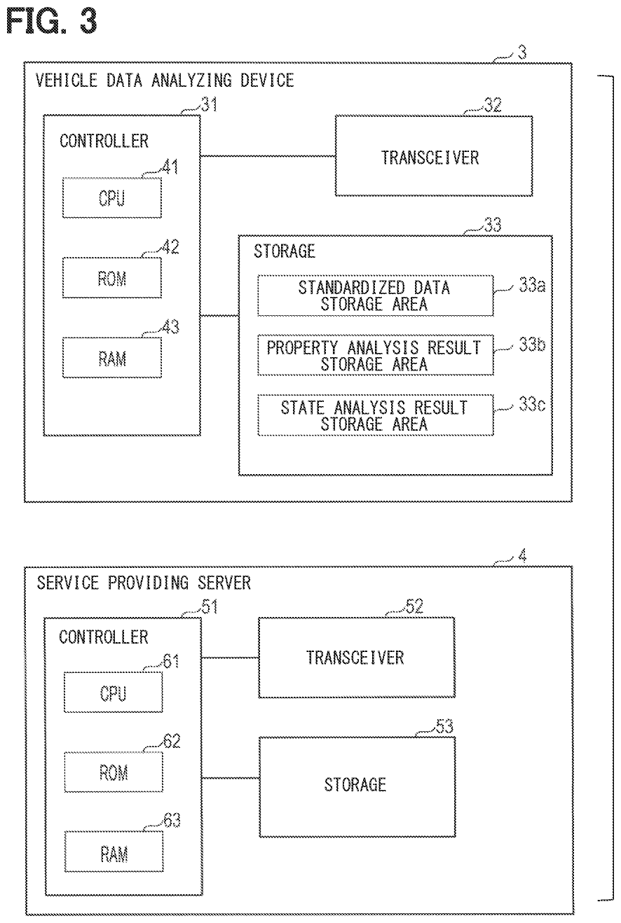

As shown in FIG. 2, the data collecting device 2 includes a controller 11, a CAN communicator 12, a storage 13, and a transceiver 14. The CAN is an abbreviation for Controller Area Network. The CAN is a registered trademark.

The controller 11 is an electronic control unit mainly including a microcomputer or microcontroller having a CPU, a ROM, a RAM, and the like. Various functions of the microcomputer are realized by causing the CPU to execute a program stored in a non-transitory tangible storage medium. In this example, the ROM 22 corresponds to a non-transitory tangible storage medium in which a program is stored. In addition, by executing this program, a method corresponding to the program is executed. Note that a part or all of the functions to be executed by the CPU 21 may be configured as hardware circuitry by one or multiple ICs or the like. The number of microcomputers configuring the controller 11 may be one or more.

The CAN communicator 12 is connected to a plurality of ECUs via a communication line so as to be capable of data communication, and transmits/receives data according to the CAN communication protocol. Specifically, the plurality of ECUs connected to the CAN communicator 12 include an engine ECU that controls the engine, a brake ECU that controls the brake, a steering ECU that controls the steering, a suspension ECU that controls the suspension, an ECU that controls on/off of a light, and the like. FIG. 2 shows only the ECU 111, the ECU 112, and the ECU 113 as the ECUs connected to the CAN communicator 12.

The storage 33 is a memory device for storing various data. The storage 33 is provided with a raw data storage area 13a and a standardized data storage area 13b. The transceiver 14 performs data communication with the vehicle data analyzing device 3 via the wireless wide area communication network NW. The transceiver 14 may transmit the data in the storage 13 with predetermined time intervals or in response to a request from the vehicle data analyzing device 3.

As shown in FIG. 3, the vehicle data analyzing device 3 includes a controller 31 a transceiver 32, and a storage 33. The controller 31 is an electronic control unit including as a main component a microcomputer (i.e., microcontroller) having a CPU 41, a ROM 42, a RAM 43, and the like. Various functions of the microcomputer are realized by the CPU 41 executing a program stored in a non-transitory tangible storage medium. In this example, the ROM 42 corresponds to a non-transitory tangible storage medium that stores a program. In addition, by executing this program, a method corresponding to the program is executed. Note that a part or all of the functions to be executed by the CPU 41 may be configured as hardware circuitry by one or multiple ICs or the like. The number of microcomputers configuring the controller 31 may be one or more.

The transceiver 32 performs data communication with the plurality of data collecting devices 2 and the service providing server 4 via the wireless wide area communication network NW. The storage 33 is a memory device for storing various data. The storage 33 is provided with a standardized data storage area 33a, a property analysis result storage area 33b, and a state analysis result storage area 33c.

The service providing server 4 includes a controller 51, a transceiver 52, and a storage 53. The controller 51 is an electronic control device mainly including a microcomputer (i.e., microcontroller) having a CPU, a ROM, a RAM, and the like. Various functions of the microcomputer are realized by causing the CPU to execute a program stored in a non-transitory tangible storage medium. In this example, the ROM 62 corresponds to a non-transitory tangible storage medium that stores a program. In addition, by executing this program, a method corresponding to the program is executed. Note that a part or all of the functions to be executed by the CPU 61 may be configured as hardware circuitry by one or multiple ICs or the like. The number of microcomputers configuring the controller 31 may be one or more.

The transceiver 52 performs data communication with the plurality of data collecting devices 2 and the vehicle data analyzing device 3 via the wireless wide area communication network NW. The storage 53 is a memory device for storing various data. The storage 53 stores not only the data received from the vehicle but also the information (for example, personal information, access information, etc.) necessary for providing the service (for example, providing an advertisement).

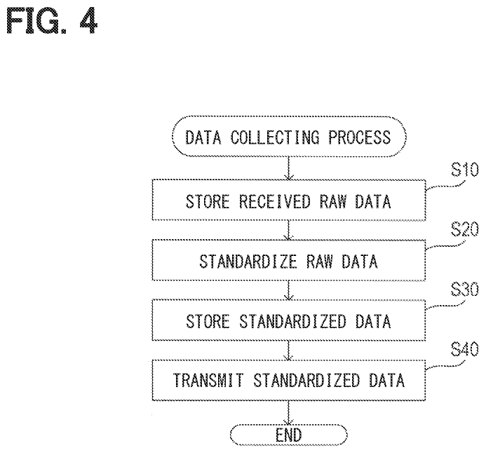

Next, the procedure of the data collecting process executed by the controller 11 of the data collecting device 2 will be described. The data collecting process is a process that is repeatedly executed during the operation of the data collecting device 2. When the data collecting process is executed, the CPU 21 of the controller 11 first stores the raw data received from the plurality of ECUs connected to the CAN communicator 12 in the raw data storage area 13a in the storage 13 in S10, as shown in FIG. 4. Raw data includes (i) vehicle behavior such as engine speed, vehicle speed, and accelerator opening, (ii) parts states such as wear and temperature of vehicle parts, and (iii) images of the inside and outside of the service target vehicle.

In S20, the CPU 21 standardizes the raw data stored in the raw data storage area 13a. The standardization is to convert the raw data, which differ depending on the vehicle types, into a common format so that the vehicle data analyzing device 3 can uniformly process the raw data. In S30, the CPU 21 stores the raw data standardized in S20 as standardized data in the standardized data storage area 13b of the storage 13. In S40, the CPU 21 transmits the standardized data stored in the standardized data storage area 13b, to the vehicle data analyzing device 3 together with the vehicle identification number for identifying the service target vehicle.

Next, the data analyzing process executed by the controller 31 of the vehicle data analyzing device 3 will be described. The data analyzing process is executed repeatedly during the operation of the vehicle data analyzing device 3.

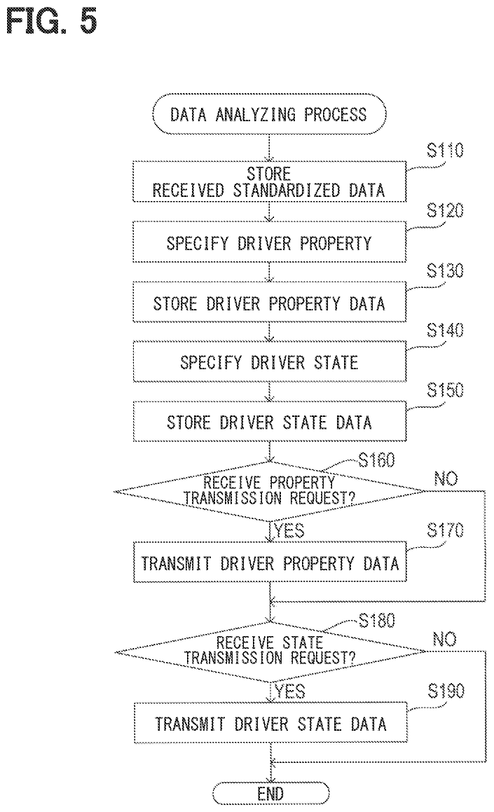

When the data analyzing process is executed, first in S110, the CPU 41 of the controller 31 stores the standardized data and the vehicle identification number received from the data collecting device 2 in the standardized data storage area 33a of the storage 33, as shown in FIG. 5.

In S120, the CPU 41 analyzes the standardized data stored in the standardized data storage area 33a, for example, the standardized data for the most recent one month, and specifies the property of the driver who drives the service target vehicle with respect to each service target vehicle.

Specifically, the CPU 41 first determines the driving characteristic of the driver based on, for example, standardized data for the most recent one month. The driving characteristic indicates (i) the operation property when the driver operates various devices and (ii) the change characteristic of the vehicle depending on the operation result.

The driving characteristic includes, for example, sudden acceleration, complete stepping on accelerator pedal, sudden braking, steep steering wheel, inter-vehicle distance to a vehicle in front in following the vehicle, re-starting timing when following a vehicle in front, interruption of another vehicle, overtaking of another vehicle, turn signal timing, and engine braking.

Sudden acceleration is determined based on the acceleration obtained from the acceleration sensor. Complete stepping on accelerator pedal is determined based on the stepping amount acquired from the accelerator opening sensor. Sudden braking is determined based on the amount of braking obtained from the brake control device. The steep steering wheel is determined based on the steering angle obtained from the steering sensor. The inter-vehicle distance and re-starting timing when following the vehicle in front are determined based on the distance to the vehicle in front acquired from the front monitoring device. The interruption and overtaking of another vehicle are determined by analyzing the image of the other vehicle acquired from the front monitoring device. The turn signal timing is determined based on the turn signal operation state acquired from the turn signal generator. The engine braking is determined based on engine speed.

Next, the CPU 41 specifies the property on driving behavior of the driver (hereinafter referred to as a driver property) based on the combination of the determination results of the plurality of driving characteristics. The driver property is determined as an individual comparison to the whole. In other words, the driver property is determined as a comparison of an individual driver (i.e., one driver or a specific driver) with a plurality of drivers.

Note that the above driver property, which may also be referred to as a usual driver property, may be defined as a property of an individual driver (or a specific driver) among properties of a plurality of drivers respectively driving a plurality of vehicles. Such a usual driver property, which also be referred to as an average driver property, may be obtained based on a comparison or a difference of the vehicle data collected in the vehicle driven by an individual driver for the last first period of time (e.g., for the last one month) against (ii) the vehicle data collected in the plurality of vehicles driven respectively by the plurality of drives for the same last first period of time.

Further, a driver state, which will be described later, may also be referred as a present driver property. Such a present driver property may be obtained based on a comparison or difference of (i) the vehicle data collected in the vehicle driven by the individual driver for the last second period of time (e.g., the last few hours) against (ii) the vehicle data collected in the vehicle driven by the individual driver for the last first period of time (e.g., for the last one month) that is longer than the second period of time.

Yet further, the present driver property may be obtained based on a comparison or difference of (i) the vehicle data collected in the vehicle driven by the individual driver for the last second period of time (e.g., the last few hours) against (ii) the vehicle data collected in the plurality of vehicles driven respectively by the plurality of drivers for the same last second period of time.

The driver property indicates the tendency of the driver's driving behavior and is specified from multiple perspectives based on the combination of the determination results of a plurality of driving characteristics. The driving characteristics are assigned with respective standard values as standard determination results. The CPU 41 compares this standard value with the determination result of the driving characteristic determined at the present time, and specifies the driver property having the highest similarity rate as the driver property at the present time. Note that a model capable of specifying the driver property by learning may be prepared in advance, and the standardized data of the driver for the most recent one month may be input to the model to specify the driver property.

The driver property can be broadly divided into (i) the property of regarding a car as a means of transportation, such as when driving at work, and (ii) the property of enjoying driving, such as when driving on holidays, and may be further subdivided into the followings.

The driver property of regarding a car as a means of transportation is assumed to include “Quick” that prioritizes time, “Safety” that prioritizes safety, “Peace” that prioritizes cooperation, “Law” that prioritizes regulations, and “Careful” that prioritizes leeway. Then, the driver property of regarding a car as a means of transportation is set as follows based on the combination of the determination results of the plurality of driving characteristics.

“Quick” is a driver property that is set when acceleration, sudden start, and steep steering wheel occur frequently, the margin of the inter-vehicle distance with the vehicle in front is small, and the re-start timing when following the vehicle in front is not sufficient. “Quick” is a driver property of a driver who wants to arrive early even if fuel efficiency is poor.

“Safety” is a driver property that is set when sudden acceleration, sudden start, and steep steering wheel do not occur frequently, the inter-vehicle distance with the vehicle in front is sufficiently large, and the engine braking is used infrequently. “Safety” is a driver property of a driver who wants to arrive safely at the latest,

“Peace” is a driver property that is set when sudden acceleration, sudden start, and steep steering wheel do not occur frequently, and there are frequent concessions that allow interruption of another vehicle. “Peace” is a driver property of a driver who wants to drive while making a compromise with others at the latest.

“Law” is a driver property that is set when sudden acceleration, sudden start, and steep steering wheel do not occur frequently, and the inter-vehicle distance with the vehicle in front is always appropriate. “Law” is a driver property of a driver who drives while thinking that legal compliance is the first priority.

“Careful” is a driver property that is set when sudden acceleration, sudden start, and steep steering wheel do not occur frequently, the inter-vehicle distance with the vehicle in front is always sufficient, and the engine braking is frequently used. “Careful” is a driver property of a driver who wants to drive slowly while thinking that the driver only has to arrive at some time.

The driver property of enjoying driving is assumed to include “Eco” that prioritizes eco, “Sport” that prioritizes agility, “Dynamic” that prioritizes speed, “Smart” that prioritizes smart, and “Self-paced” that prioritizes self-paced. Then, the driver property of enjoying driving is set as follows based on the combination of the determination results of a plurality of driving characteristics.

“Eco” is a driver property that is set when sudden acceleration, sudden start, and steep steering wheel do not occur frequently, and when engine braking is frequently used. “Eco” is a driver property of a driver who wants to drive eco-friendly.

“Sport” is a driver property set when sudden acceleration, sudden start, and steep steering wheel occur frequently, and overtaking of another vehicle frequently occurs. “Sport” is a driver property of a driver who wants to drive sharply even if fuel efficiency is poor.

“Dynamic” is a driver property set when sudden acceleration, sudden start, and steep steering wheel frequently occur, and late turn signal timing frequently occurs. “Dynamic” is a driver property of a driver who drives while wanting to drive at high speed with love to speed.

“Smart” is a driver property that is set when (i) frequent sudden acceleration, sudden start, and steep steering wheel do not occur frequently,(ii) the inter-vehicle distance with the vehicle in front is appropriate, (iii) the engine braking is frequently used, and (iv) there are frequent concessions that allow interruptions from other vehicles. “Smart” is a driver property of a driver who wants to drive smartly according to the road and environment.

“Self-paced” is a driver property that is set when sudden acceleration, sudden start, and steep steering wheel occur frequently, and the speed change of the vehicle occurs frequently. “Self-paced” is a driver property of a driver who wants to drive at his/her own pace.

In the present embodiment, the driver properties are roughly classified into the case where a car is regarded as a means of transportation and the case where the driver enjoys driving, but the driver properties other than those may be classified. In addition, either the case where a car is regarded as a means of transportation or the case where the driver enjoys driving may be adopted. The determination criteria for determining the driver properties may employ the determination criteria other than the above-mentioned determination criteria, or other driving characteristics may be employed.

In S130, the CPU 41 stores the driver property data indicating the driver property specified for each service target vehicle in S120 in the property analysis result storage area 33b of the storage 33. In S140, the CPU 41 analyzes the standardized data stored in the standardized data storage area 33a, for example, the standardized data for the last few hours, and the state of the driver (hereinafter, the driver state) for each service target vehicle. The driver state is determined as a comparison between the average (i.e., usual) driver property and the present driver property of the same individual (i.e., same driver),

Specifically, the CPU 41 first determines the driving characteristic of the driver based on, for example, standardized data for the last few hours. Since the method for determining the driving characteristics is the same as that for S120, the description thereof will be omitted. Next, the CPU 41 specifies the driver property based on the combination of the determination results of the plurality of driving characteristics. Since the method for specifying the driver property is the same as that for S120, the description thereof will be omitted. Then, the CPU 41 specifies the driver property specified in S140 as the driver state for each service target vehicle.

In S150, the CPU 41 stores the driver state data indicating the driver state specified in S140 in the state analysis result storage area 33c of the storage 33. The driver state data indicates the driver state specified in S140 for each service target vehicle.

The CPU 41 determines in S160 whether or not be property transmission request is received from the service providing server 4. Here, when the property transmission request is not received, the CPU 41 shifts to S180. On the other hand, when the property transmission request is received, the CPU 41 transmits the driver property data stored in the property analysis result storage area 33b, to the service providing server 4 in S170, and shifts to S180.

After shifting to S180, the CPU 41 determines whether or not a state transmission request is received from the service providing server 4. Here, if the state transmission request is not received, the CPU 41 ends the data analyzing process. On the other hand, when the state transmission request is received, the CPU 41 transmits the driver state data stored in the state analysis result storage area 33c, to the service providing server 4 via the transceiver 32 in S100, and ends the data analyzing process, Here, the driver property may be specified when the property transmission request is received; the driver state may be specified when the state transmission request is received.

The service providing server 4 transmits predetermined service information to the mobile terminal 5 or the like by using the driver property data and the driver state data received from the vehicle data analyzing device 3. Examples of the service provided by the service providing server 4 include a warning service for a young driver and a watching service for the parents of the young driver.

Specifically, the service provided by the service providing server 4 is a service contracted for each young user who drives. The data collecting device 2 detects the start of driving in conjunction with the vehicle key system, and starts (i) accumulating raw data and (ii) transmitting standardized data and a vehicle identification number. The service providing server 4 detects a difference from usual for each driving of the user based on the driver property data and the driver state data acquired from the vehicle data analyzing device 3, and notifies the user and the user's parents of the detected difference. The service providing server 4 includes a user association table for associating a vehicle identification number, a user's e-mail address, and an e-mail address of the users parents.

Further, the service providing server 4 infers the user's tendency from the difference between the driving of the user and the driving of another person based on the driver property data acquired from the vehicle data analyzing device 3. The service providing server 4 notifies the user's parents of how it is effective to give safety guidance to the user, with example sentences.

Further, for instance, when the driver property is “Law” and the driver state is “Quick”, the service providing server 4 may notify the driver of “It looks like you're in a hurry today. Try to drive properly as usual”.

Further, for example, when the driver property is “Safety”, the service providing server 4 notifies the driver of a content that picks up a particularly safe driving operation and a particularly accurate driving operation and compliments the driver.

Further, for example, when the driver property is “Dynamic”, the service providing server 4 notifies the driver of a content that makes the driver aware that an appropriate inter-vehicle distance leads to an early arrival as a result, and points out dangerous driving.

Further, for example, when the driver state is “Sport”, the service providing server 4 notifies the driver of a content indicating that excessive overtaking is dangerous. The information providing system 1 configured in this way includes a plurality of data collecting devices 2, a vehicle data analyzing device 3, and a service providing server 4.

The plurality of data collecting devices 2 are mounted, respectively, on the plurality of vehicles (i.e., host vehicles), and transmit vehicle data including at least information on the traveling of the host vehicles. The vehicle data analyzing device 3 receives vehicle data from the plurality of data collecting devices 2, analyzes the driver property and the driver state with respect of each of the plurality of vehicles based on the received vehicle data, and transmits the driver property data and driver state data with respect to each of the plurality of vehicles or with respect to each of the plurality of drivers respectively corresponding to the plurality of vehicles.

The service providing server 4 receives the driver property data and the driver state data from the vehicle data analyzing device 3, generates the provision information with respect to each of the plurality of drivers respectively corresponding to the plurality of vehicles based on the driver property data and the driver state data, and transmits the generated provision information to the mobile terminal 5 held by each of the plurality of drivers. The provision information is a reminder to the younger driver to notify them of any differences from usual.

The information providing system 1 configured in this way can provide effective information to the driver for each driver based on at least one of the driver property and the driver state (i.e., based on the driver property, or the driver state, or both the driver property and the driver state), and improve the usefulness in providing the information.

In the embodiment described above, the data collecting device 2 corresponds to an in-vehicle device, the mobile terminal 5 corresponds to a terminal device, the driver property corresponds to a property relative to the traveling of the driver, and the driver state corresponds to a state relative to traveling of the driver.

In addition, the driver property data and the driver state data correspond to the analysis result data, and the alert that notifies the difference from usual is the information about the service. Further, the transceiver 32 corresponds to the vehicle data acquisition unit, S120 and S140 correspond to the process as the driver analysis unit, and S160 to S190 correspond to the process as the analysis result transmission unit.

### Second Embodiment

Hereinafter, a second embodiment of the present disclosure will be described with reference to the drawings. Note that in the second embodiment, portions different from the first embodiment will be described. The same reference signs are given to common elements.

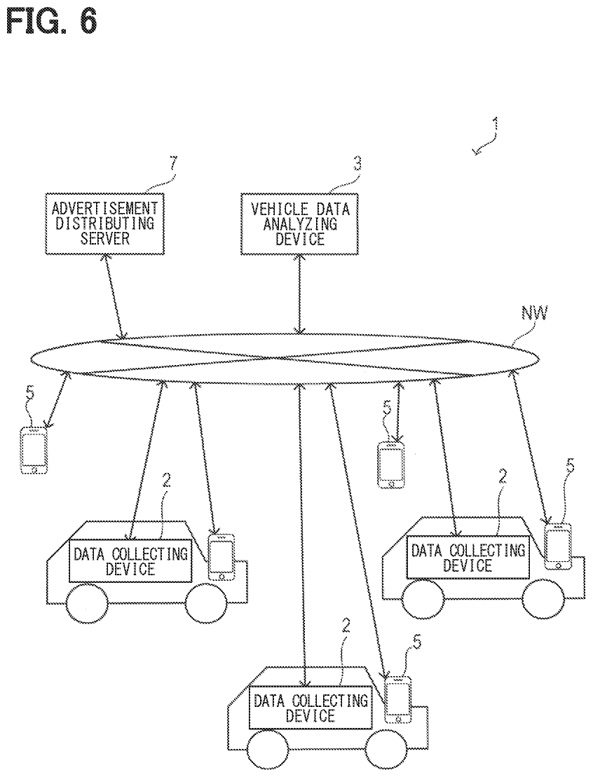

As shown in FIG. 6, the information providing system 1 of the second embodiment is different from the first embodiment in that it includes an advertisement distributing server 7 instead of the service providing server 4. The advertisement distributing server 7 acquires analysis data from the vehicle data analyzing device 3 via the wireless wide area communication network NW. Then, the advertisement distributing server 7 has a function of distributing an advertisement to a plurality of mobile terminals 5 via the wireless wide area communication network NW based on the acquired analysis data.

The vehicle data analyzing device 3 of the second embodiment is different from the first embodiment in that the data analyzing process is different. Next, the procedure of the data analyzing process of the second embodiment will be described.

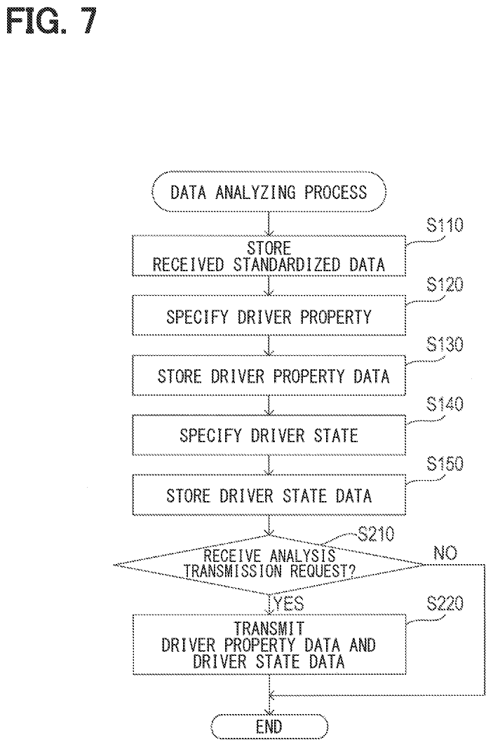

The data analyzing process of the second embodiment is different from the first embodiment in that the processing in S160 to S199 are omitted and the processing in S210 to S220 are added. That is, as shown in FIG. 7, when the processing in S150 is completed, the CPU 41 determines in S210 whether or not the analysis transmission request is received from the advertisement distributing server 7. The analysis transmission request is assigned with a vehicle identification number of the service target vehicle for which data transmission is desired.

Here, if the analysis transmission request is not received, the CPU 41 ends the data analyzing process. On the other hand, when the analysis transmission request is received, the CPU 41 transmits the driver property data and the driver state data corresponding to the vehicle identification number assigned to the analysis transmission request, to the advertisement distributing server 7 in S220, and ends the data analyzing process.

The advertisement distributing server 7 uses the driver property data and the driver status data received from the vehicle data analyzing device 3 to transmit a web advertisement with a targeting attribute derived from the vehicle to the mobile terminal 5 or the like.

Specifically, when the user accesses the website, the website transmits the advertisement distribution request together with the cookie information to the advertisement distributing server 7. The advertisement distributing server 7 specifies the tendency of the user based on the cookie information assigned to the advertisement distribution request, and further, ties the specified tendency with the driver ID of the driver who is driving the service target vehicle based on the user's ID. The vehicle data analyzing device 3 includes an ID linkage association table that associates the user ID with the driver ID. Then, the advertisement distributing server 7 transmits an analysis transmission request, which the driver ID of the driver who is driving the service target vehicle is assigned to, to the vehicle data analyzing device 3. After that, when the advertisement distributing server 7 receives the driver property data and the driver state data from the vehicle data analyzing device 3, the advertisement distributing server 7 distributes an advertisement to the website based on the received driver property data and the driver state data.

For example, when a fishing enthusiast is browsing a news site, the advertisement distributing server 7 acquires the driver property data and the driver state data of the user from the vehicle data analyzing device 3. It is assumed that the acquired driver property data and the driver state data indicate that the usual driver property is “Law” and the present driver property is “Quick”. In this case, the advertisement distributing server 7 determines that the above-mentioned user is “easy to accept the grounded profit information” based on the above-mentioned driver property data and the above-mentioned driver state data, and distributes an advertisement to the above news site to guide “the only time sale of high quality fishing rods”. As a result, the above-mentioned guidance advertisement is displayed on the news site that the above-mentioned user is browsing on the mobile terminal 5 The information providing system 1 configured in this way includes a plurality of data collecting devices 2, a vehicle data analyzing device 3, and an advertisement distributing server 7. The plurality of data collecting devices 2 are mounted respectively on the plurality of vehicles (i.e., host vehicles), and transmit vehicle data including at least information on the traveling of the host vehicles,

The vehicle data analyzing device 3 receives vehicle data from the plurality of data collecting devices 2, analyzes the driver property and the driver state with respect to each of the plurality of vehicles or with respect to each of the plurality of drivers respectively corresponding to the plurality of vehicles based on the received vehicle data, and transmits the driver property data and driver state data.

The advertisement distributing server 7 receives the driver property data and the driver state data from the vehicle data analyzing device 3, generates the provision information with respect to each of the plurality of drivers based on the driver property data and the driver state data, and transmits the generated provision information to the mobile terminal 5 held by each of the plurality of drivers. The provision information is information indicating the content of the advertisement.

The advertisement distributing server 7 determines the content of the advertisement based on (i) the cookie information on website accessed by the drivers mobile terminal 5, (ii) the driver property data, and (iii) the driver state data, and transmits the provision information indicating the determined content of the advertisement to the driver's mobile terminal 5.

Further, the advertisement distributing server 7 requests the vehicle data analyzing device 3 to transmit the driver property data and the driver state data when the driver's mobile terminal 5 accesses the website.

The information providing system 1 configured in this way can provide effective information to each of the drivers based on the driver property and the driver state, and improve the usefulness in providing the information.

In the embodiment described above, the advertisement distributing server 7 corresponds to the information providing device, the driver property data and the driver state data correspond to the analysis result data, and the cookie information corresponds to the access information.

### Third Embodiment

Hereinafter, a third embodiment of the present disclosure will be described with reference to the drawings. Note that in the third embodiment, portions different from the second embodiment will be described, The same reference signs are given to common elements.

The information providing system 1 of the third embodiment is different from the second embodiment in that the data analyzing process is different. Next, the procedure of the data analyzing process of the third embodiment will be described.

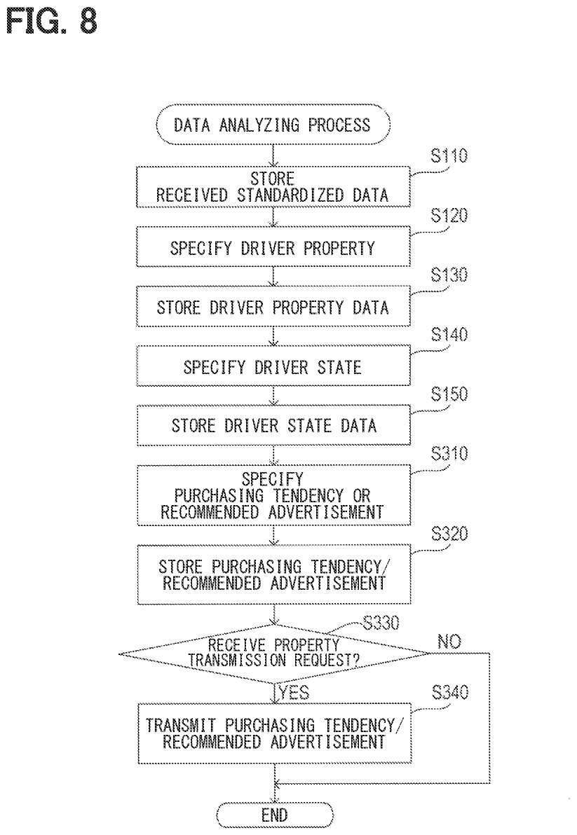

The data analyzing process of the third embodiment is different from the first embodiment in that the processing in S210 to S220 are omitted and the processing in S310 to S340 are added. That is, as shown in FIG. 8, when the processing in S150 is completed, the CPU 41 of the controller 31 specifies, in S310, the purchasing tendency or recommended advertisement of the driver who drives the service target vehicle for each service target vehicle based on (i) the driver property data stored in the storage 33 and (ii) the purchase tendency/recommended advertisement table stored in the storage 33.

The purchasing tendency/recommended advertisement table associates the driver property with the purchasing tendency or recommended advertisement. For example, in the driver property of “a driver who drives while wanting to drive at high speed with love to speed”, it is possible to interpret that “only oneself benefits, and burning when pushing people away”. For this reason, in the purchasing tendency/recommended advertising table, the driver property of “a driver who drives while wanting to drive at high speed with love to speed” is associated with purchasing tendency of “there is a possibility of purchasing for rewards such as time sale and limited to the first 10 people”.

In addition, the driver property of “a driver who drives while wanting to drive eco-friendly” can be interpreted as “highly conscious of the natural life and eco-life.” For this reason, in the purchasing tendency/recommended advertising table, the driver property of “a driver who drives while wanting to drive eco-friendly” is associated with the purchasing tendency that “there is a possibility to purchase high quality products, eco-friendly and socially meaningful products, and introductions of initiatives (for example, partial sales donations)”.

In addition, the driver property of “Quick” can be interpreted as “impatient, narrow field of vision, and influence by surroundings”. For this reason, in the purchasing tendency/recommended advertisement table, the driver property of “Quick” is associated with the recommended advertisement of “recommended with the background that everyone is buying and selling out soon”.

In addition, the driver property of “Safety” can be interpreted as “safety first, loneliness tendency”. For this reason, in the purchasing tendency/recommended advertisement table, the driver property of “Safety” is associated with the recommended advertisement of “recommending good quality, safe production area and safe function”.

In addition, the driver property of “Peace” can be interpreted as “pacifism, which sacrifices oneself for the sake of others”. For this reason, in the purchasing tendency/recommended advertisement table, the driver property of “Peace” is associated with the recommended advertisement “Popularity ranking of gifts, complex products (for example, deodorant) are recommended”.

In addition, the driver property of “Law” can be interpreted as “highly autonomous, observing rules, and cooperative”. For this reason, in the purchasing tendency/recommended advertising table, the driver property of “Law” is associated with the recommended advertisements that “recommend legitimate products of legitimate companies (for example, those that are not too cheap due to human rights violations) and those that benefit the world (for example, security cameras)”.

In addition, the driver property of “Careful” can be interpreted as “safety-oriented, pacifist, and lack of self-confidence.” For this reason, in the purchasing tendency/recommended advertisement table, the driver property of “Careful” is associated with the recommended advertisement of “recommended with ranking and word of mouth that everyone likes”.

In addition, the driver property of “Eco” can be interpreted as “highly conscious of natural life, eco-life, and savings.” For this reason, in the purchasing tendency/recommended advertising table, the driver property of “Eco” is associated with a recommended advertisement that says, “We recommend cheap products, products with large discount rates, products with ecological and social significance, and initiatives (for example, donations of partial sales).”

In addition, the driver property of “Sport” can be interpreted as “only oneself benefits, and burning when pushing people away”. Therefore, in the purchasing tendency/recommended advertisement table, the driver property of “Sport” is associated with the recommended advertisement of “recommended time sale or limited to the first 10 people”.

In addition, the driver property of “Dynamic” can be interpreted as “I'm impatient and the surroundings should suit me.” For this reason, in the purchasing tendency/recommended advertisement table, the driver property of “Dynamic” is associated with the recommended advertisement “Recommended time sale or limited to the first 10 people”.

In addition, the driver property of “Smart” can be interpreted as “harmonizing with the whole and caring for others.” For this reason, in the purchasing tendency/recommended advertisement table, the driver property of “Smart” is associated with the recommended advertisement of “recommending information on social contributions, products with a cause, and gifts.”

In addition, the driver property of “Self-paced” can be interpreted as “I am particular about myself and do not care about other people.” For this reason, in the purchasing tendency/recommended advertisement table, the driver property of “Self-pace” is associated with a recommended advertisement that says, “Recommend unique things that are different from people, and recommend things that are similar to those purchased once.”

Then, in S320, the CPU 41 stores in the storage 33 the purchasing tendency/recommended advertisement data indicating the purchasing tendency or the recommended advertisement specified for each service target vehicle in S310. Next, the CPU 41 determines in S330 whether or not the analysis transmission request is received from the advertisement distributing server 7. The analysis transmission request is assigned with a vehicle identification number of the service target vehicle for which data transmission is desired.

Here, if the analysis transmission request is not received, the CPU 41 ends the data analyzing process. On the other hand, when the analysis transmission request is received, the CPU 41 transmits the purchase tendency/recommended advertisement data corresponding to the vehicle identification number assigned to the analysis transmission request, to the advertisement distributing server 7 in S340 to analyze the data, and ends the process.

The advertisement distributing server 7 uses the purchase tendency/recommended advertisement data received from the vehicle data analyzing device 3 to transmit a web advertisement with a targeting attribute derived from the vehicle to the mobile terminal 5 or the like.

The information providing system 1 configured in this way includes a plurality of data collecting devices 2, a vehicle data analyzing device 3, and an advertisement distributing server 7. The plurality of data collecting devices 2 are mounted on each of the plurality of vehicles (i.e., host vehicles), and transmit vehicle data including at least information on the traveling of the host vehicles.

The vehicle data analyzing device 3 receives vehicle data from the plurality of data collecting devices 2, analyzes the driver characteristics of each of the plurality of vehicles based on the received vehicle data, and further transmits the purchase tendency/recommended advertisement data obtained by analyzing the purchase tendency or the recommended advertisement using the driver property.

The advertisement distributing server 7 receives the purchase tendency/recommended advertisement data from the vehicle data analyzing device 3, generates the provision information based on the purchase tendency/recommended advertisement data, and transmits the generated provision information to the mobile terminal 5 held by the driver. The provision information is information indicating the content of the advertisement.

The information providing system 1 configured in this way can provide effective information to the driver for each driver based on the driver property, and can improve the usefulness in providing the information.

In the embodiments described above, the purchasing tendency/recommended advertisement data corresponds to the analysis result data. As described above, the embodiments of the present disclosure have been described, but the present disclosure is not limited to the above embodiments, and can be implemented with various modifications.

### First Modification Example

For example, in the second embodiment described above, the advertisement distributing server 7 distributes an advertisement to a website based on the received driver property data and driver state data. However, the vehicle data analyzing device 3 may determine the user's preference behavior pattern corresponding to the vehicle identification number based on the driver property data and the driver state data corresponding to the vehicle identification number assigned to the analysis transmission request, and transmit the preference behavior pattern to the advertisement distributing server 7. For example, when a fishing enthusiast user is browsing a news site, the advertisement distributing server 7 may transmit an analysis transmission request to which the user's vehicle identification number is assigned to the vehicle data analyzing device 3. The vehicle data analyzing device 3 transmits a preference behavior pattern flag corresponding to “easy to accept valid profitable information” to the advertisement distributing server 7 based on the driver property data and the driver state data corresponding to the vehicle identification number assigned to the analysis transmission request. It is assumed that the above-mentioned driver property data and driver state data indicate that the usual driver property is “Law” and the present driver property is “Quick”. The advertisement distributing server 7 distributes an advertisement for guiding “a time sale of a high quality fishing rod only for now” to the above news site based on the preference behavior pattern flag transmitted from the vehicle data analyzing device 3.

### Second Modification Example

In the above embodiments, the driver property data shows an example in which one driver property is shown from among a plurality of driver properties such as “Quick” and “Safety” for each driver. However, the driver property data may indicate a plurality of driver properties in a ranking in descending order of reliability that matches the driver properties.

### Third Modification Example

In the above embodiments, the provision information is transmitted to the driver's mobile terminal 5, but the provision information may be transmitted to the navigation device mounted on the vehicle.

### Fourth Modification Example

In the above embodiments, the data collecting device 2 shows an example of collecting data (that is, vehicle-derived data) from ECUs 111 to 113 via the CAN communicator 12. However, the data collecting device 2 may collect data derived from the human body (for example, pulse) and data derived from the environment outside the vehicle (for example, image data taken by the camera outside the vehicle) in addition to the data derived from the vehicle.

### Fifth Modification Example

In the above embodiments, an example is shown in which the provision information is generated for each driver based on the access information about the website accessed by the terminal device of the driver and the analysis result data.

However, the behavior information other than driving by the driver may include a behavioral preference in addition to accessing the website. For example, behavioral preference is such as “I like fishing, reading, traveling, etc.” or “I often go to movie theaters, amusement parks, and Aichi prefecture”.

### Sixth Modification Example

In the above embodiments, an example in which a product advertisement is displayed based on a driver property and a driver state is shown. However, as illustrated below, the product advertisement may be displayed based on the driver property, For example, when the driver property is “Peace”, the information providing system 1 may display a popularity ranking of gifts and an advertisement of a complex product (for example, deodorant). Also, for example, if there is a wallet browsing history on the website and the driver property is “Quick”, the information providing system 1 may display a wallet ad with the background that everyone is buying or selling out soon.

Further, the information providing system 1 may display a product advertisement based on the driver state, In this case, the driver state may include running/stopped; frustrated/relaxed and calm (compared to normal driving); or carrying a rare person next to me or running far away (unusual)/carrying no person or family or running the route of the neighborhood or routine (usual).

In addition, suppose the case where the information providing system 1 displays a product advertisement based on the driver property and the driver state. In this case, when the driver property is “Law” and the driver state is “there is the position information of the sea”, an advertisement of a high quality fishing rod may be displayed with an extensive knowledge.

In addition, suppose the case where the information providing system 1 analyzes the purchasing tendency using the driver property and displays a product advertisement. In this case, when the driver property of “a driver who drives while wanting to drive at high speed with love to speed”, the purchasing tendency may be specified as “there is a possibility of purchasing for rewards such as time sale and limited to the first 10 people”, and the first 10 time sale advertisements for branded wallets may be displayed. Further, suppose the case where the information providing system 1 is, for example, when the driver property is “driving while wanting to drive eco-friendly”. In this case, the purchasing tendency may be specified as “there is a possibility of purchasing for high-quality products, products with ecological and social significance, and introductions of initiatives (for example, partial sales donations)”, and an advertisement for a wallet made by a craftsman in charity sales may be displayed. Further, suppose the case where the information providing system 1 is, for example, when the driver property is “Safety”. In this case, the purchasing tendency may be specified as “recommended products with good quality and safe production areas and functions”, and an advertisement for a wallet in a well-established store of good quality may be displayed.

In addition, suppose the case where the information providing system 1 analyzes the purchasing tendency using the driver state and displays the product advertisement. In this case, when the driver state is “extraordinary outing”, the purchasing tendency may be specified as “I want to eat delicious local food even if I spoil myself”, and a restaurant that serves local brand beef even at a higher price range than usual may be introduced.

In addition, suppose the case where the information providing system 1 analyzes the purchasing tendency using the driver property and the driver state and displays a product advertisement. In this case, when the driver property is “Law” and the driver state is “driving to the sea several times”, the purchasing tendency may be specified as “easy to accept valid profit information”, and an advertisement for a high quality fishing rod may be displayed with an extensive knowledge.

### Seventh Modification Example

In the above embodiments, an example is shown in which the content of notification in the alert service and the watching service is determined based on at least one of the driver property and the driver state. However, the tendency may be specified based on at least one of the driver property and the driver state, and the notification content may be determined based on the tendency. For example, when the driver property is “Safety”, the information providing system 1 may pick up and praise the fact that the driver is able to drive accurately and safely. Further, the information providing system 1 may point out dangerous driving while making the driver aware that an appropriate inter-vehicle distance will eventually lead to early arrival when the driver property is “Dynamic”.

The controller 11, 31, 51, and the techniques thereof according to the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits. Further, the computer program may be stored in a computer-readable non-transitory tangible storage medium as instructions to be executed by a computer. The technique for realizing the functions of each unit included in the controller 31 does not necessarily need to include software, and all the functions may be realized using one or a plurality of hardware circuits.

The multiple functions of one component in the above embodiments may be realized by multiple components, or a function of one component may be realized by the multiple components. In addition, multiple functions of multiple components may be realized by one component, or a single function realized by multiple components may be realized by one component. Moreover, part of the configuration of the above-described embodiment may be omitted. Further, at least part of the configuration of the above-described embodiment may be added to or replaced with the configuration of another embodiment described above.

In addition to the above-mentioned information providing system 1 and vehicle data analyzing device 3, the present disclosure can be realized in various forms such as a program for operating a computer as the information providing system 1 and the vehicle data analyzing device 3, a non-transitory tangible storage medium such as a semiconductor memory in which the program is stored, and an information providing method.

For reference to further explain features of the present disclosure, the description is added as follows.

There is a technique for distributing information according to a state transition of a user's behavior when the user moves using a vehicle.

The technique described above poses an issue that information distribution is limited to information related to state transitions of behavior using a vehicle. It is thus desired to improve the usefulness in providing information.

Aspects of the present disclosure described herein are set forth in the following clauses.

According to a first aspect of the present disclosure, an information providing system is provided to include a plurality of in-vehicle devices, a vehicle data analyzing device, and an information providing device.

The plurality of in-vehicle devices are configured to transmit vehicle data including at least information on traveling of the plurality of vehicles, respectively.

The vehicle data analyzing device is configured to (i) receive the vehicle data from the plurality of in-vehicle devices, and (ii) analyze, based on the received vehicle data, at least one that is a property, or a state, or both the property and the state. Herein, each of the proper and the state is relative to traveling of one driver who is any one of the plurality of drivers; the property relative to the traveling of the one driver is expressed as a comparison with the plurality of drivers; the state relative to the traveling of the one driver is expressed as a comparison of the state at present with the state in usual. The vehicle data analyzing device is further configured to (iii) output an analysis result data that expresses one analysis result of two analysis results being a first analysis result and a second analysis result. Herein, the first analysis result is expressing the analyzed at least one; the second analysis result is obtained by analysis using the first analysis result.

The information providing device is configured to transmit provision information to a terminal device held by the one driver. Herein, the provision information is generated with respect to the one driver based on the analysis result data outputted from the vehicle data analyzing device.

The information providing system according to the first aspect of the present disclosure can provide valid information to the respective drivers based on at least one of the above-mentioned property and the above-mentioned state of the driver (i.e., based on the property or the state or both the property and the state), improving the usefulness in providing information.

According to a second aspect of the present disclosure, a vehicle data analyzing device is provided to include a vehicle data acquisition unit, a driver analysis unit, and an analysis result transmission unit.

The vehicle data acquisition unit is configured to acquire vehicle data from a plurality of in-vehicle devices mounted respectively in a plurality of vehicles that are driven respectively by a plurality of drivers, the vehicle data including at least information on traveling of the plurality of vehicles, respectively.

The driver analysis unit is configured to obtain an analysis result data by analyzing, based on the acquired vehicle data, at least one that is a proper, or a state, or both the proper and the state. Herein, each of the proper and the state is relative to traveling of one driver who is any one of the plurality of drivers; the property relative to the traveling of the one driver is expressed as a comparison with the plurality of drivers; the state relative to the traveling of the one driver is expressed as a comparison of the state at present with the state in usual.

The analysis result transmission unit is configured to output externally the analysis result data obtained by the driver analysis unit, the analysis result data expressing one of two analysis results being a first analysis result and a second analysis result. Herein, the first analysis result is expressing the analyzed at least one; the second analysis result is obtained by analysis using the first analysis result.

The vehicle data analyzing device according to the second aspect of the present disclosure is a vehicle data analyzing device used in the information providing system according to the first aspect of the present disclosure, and can obtain the same effect as the information providing system according to the first aspect of the present disclosure.

According to a third aspect of the present disclosure, an information providing method is provided to include the following steps.

The step of acquiring is acquiring vehicle data from a plurality of in-vehicle devices mounted respectively in a plurality of vehicles that are driven respectively by a plurality of drivers, the vehicle data including at least information on traveling of the plurality of vehicles, respectively.

The step of analyzing is analyzing, based on the acquired vehicle data, at least one that is a proper, or a state, or both the proper and the state. Herein, each of the proper and the state is relative to traveling of one driver who is any one of the plurality of drivers; the property relative to the traveling of the one driver is expressed as a comparison with the plurality of drivers; the state relative to the traveling of the one driver is expressed as a comparison of the state at present with the state in usual.

The step of generating is generating an analysis result data that expresses one of two analysis results being a first analysis result and a second analysis result. Herein, the first analysis result is expressing the analyzed at least one; the second analysis result is obtained by analysis using the first analysis result.

The step of transmitting is transmitting provision information to a terminal device held by the one driver. Herein, the provision information is generated with respect to the one driver based on the analysis result data.

The information providing method according to the third aspect of the present disclosure is a method executed by the information providing system according to the first aspect of the present disclosure: by executing the method, the same effect as that of the information providing system according to the first aspect of the present disclosure can be obtained.

What is claimed is:

1. An Information providing system comprising:
a plurality of in-vehicle devices mounted respectively on a plurality of vehicles that are driven respectively by a plurality of drivers;
a vehicle data analyzing device; and
an information providing device, wherein:
the plurality of in-vehicle devices are configured to transmit vehicle data including at least information on traveling of the plurality of vehicles, respectively;
the vehicle data analyzing device is configured to
(i) receive the vehicle data from the plurality of in-vehicle devices,
(ii) analyze, based on the received vehicle data, at least one that is a property, or a state, or both the property and the state,
each of the proper and the state being relative to traveling of one driver who is any one of the plurality of drivers,
the property relative to the traveling of the one driver being expressed as a comparison with the plurality of drivers,
the state relative to the traveling of the one driver being expressed as a comparison of the state at present with the state in usual_{;} and
(iii) output an analysis result data that expresses one analysis result of two analysis results being a first analysis result and a second analysis result,
the first analysis result being expressing the analyzed at least one,
the second analysis result being obtained by analysis using the first analysis result; and
the information providing device is configured to transmit provision information to a terminal device held by the one driver, the provision information being generated with respect to the one driver based on the analysis result data outputted from the vehicle data analyzing device.

2. The information providing system according to claim 1, wherein:
the provision information is information indicating an advertisement that is set based on the analysis result data with respect to the one driver.

3. The information providing system according to claim 1, wherein:
the provision information is information indicating a service that is set based on the analysis result data with respect to the one driver.

4. The information providing system according to claim 2, wherein:
the information providing device is configured to transmit the provision information that is generated with respect to the one driver based on (i) the analysis result data and (ii) information on behavior other than driving of the one driver.

5. The information providing system according to claim 4, wherein:
the information providing device is configured to
determine a content of the advertisement based on (i) access information on website accessed by the terminal device held by the one driver and (ii) the analysis result data, and
output information indicating the determined content of the advertisement to the terminal device held by the one driver, as the provision information.

6. The information providing system according to claim 5, wherein:
the information providing device is configured to request the vehicle data analyzing device to output the analysis result data in response to the terminal device held by the one driver accessing the website.

7. The information providing system according to claim 5, wherein:
the information providing device is configured to determine the content of the advertisement based on (i) the access information on website regarding a purchase, (ii) the property, and (iii) the state within a predetermined period of time from a time of accessing the website.

8. The information providing system according to claim 1, wherein:
the second analysis result is a result of analysis of a purchasing tendency or a recommended advertisement, using the first analysis result.

9. A vehicle data analyzing device comprising:
a vehicle data acquisition unit configured to acquire vehicle data from a plurality of in-vehicle devices mounted respectively in a plurality of vehicles that are driven respectively by a plurality of drivers, the vehicle data including at least information on traveling of the plurality of vehicles, respectively;
a driver analysis unit configured to obtain an analysis result data by analyzing, based on the acquired vehicle data, at least one that is a proper, or a state, or both the proper and the state,
each of the proper and the state being relative to traveling of one driver who is any one of the plurality of drivers,
the property relative to the traveling of the one driver being expressed as a comparison with the plurality of drivers,
the state relative to the traveling of the one driver being expressed as a comparison of the state at present with the state in usual;
an analysis result transmission unit configured to output externally the analysis result data obtained by the driver analysis unit, the analysis result data expressing one of two analysis results being a first analysis result and a second analysis result,
the first analysis result being expressing the analyzed at least one,
the second analysis result being obtained by analysis using the first analysis result.

10. The vehicle data analyzing device according to claim 9, further comprising:
a transceiver configured to function as the vehicle data acquisition unit; and
a controller communicably coupled to the transceiver, the controller being configured to implement the driver analysis unit and the analysis result transmission unit.

11. A computer-implemented information providing method executed by a computer, the method comprising:
acquiring vehicle data from a plurality of in-vehicle devices mounted respectively in a plurality of vehicles that are driven respectively by a plurality of drivers, the vehicle data including at least information on traveling of the plurality of vehicles, respectively;
analyzing, based on the acquired vehicle data, at least one that is a proper, or a state, or both the proper and the state,
each of the proper and the state being relative to traveling of one driver who is any one of the plurality of drivers,
the property relative to the traveling of the one driver being expressed as a comparison with the plurality of drivers,
the state relative to the traveling of the one driver being expressed as a comparison of the state at present with the state in usual;
generating an analysis result data that expresses one of two analysis results being a first analysis result and a second analysis result,
the first analysis result being expressing the analyzed at least one,
the second analysis result being obtained by analysis using the first analysis result; and
transmitting provision information to a terminal device held by the one driver, the provision information being generated with respect to the one driver based on the analysis result data.
